(19) United States
(12) Patent Application Publication
(10) Pub. No.: US 2002/0177911 A1
(43) Pub. Date: Nov. 28, 2002

(54) METHOD AND APPARATUS FOR DETERMINING AN ARRANGEMENT OF COMPONENTS

(76) Inventors: LAWRENCE WAUGH, AUSTIN, TX (US); DAN CLANCY, AUSTIN, TX (US)

Correspondence Address: THE HECKER LAW GROUP, 1925 CENTURY PARK EAST, SUITE 2300, LOS ANGELES, CA, 90067, US

(21) Appl. No.: 09/163,752

(22) Filed: Sep. 30, 1998

(51) Int. Cl. G05B 13/02

(52) U.S. Cl. 700/30

(57) ABSTRACT

A method and apparatus for determining an arrangement of components is disclosed. In accordance with a method of the invention, a number of components are arranged in a superior/inferior hierarchy. Sets of components are generated in accordance with the hierarchy of components. A first set of at least one component is selected and a determination is made as to whether the set of components satisfies a required set of characteristics. If the requirements are not satisfied, other non-inferior sets of components are evaluated. If the requirements are satisfied, other non-superior sets of components are evaluated. In one or more embodiments, each component has a total capacity and provides an amount of at least one individual resource. The determination of whether a set of components satisfies a required set of resources comprises allocating resources provided by the components of the set in an order of least to most plentiful, and in a manner whereby the allocation of each particular resource tends to equalize the difference between each component's total remaining capacity and a threshold value after the allocation. The allocation continues until all of the required resources have been satisfied or can not be satisfied. Multiple sets of components which satisfy the required characteristics may be compared to determine an optimal combination or set of components.

### BACKGROUND OF THE INVENTION

1. Field of the Invention

The invention relates to a method and an apparatus for determining an arrangement of components.

2. Background of the Invention

There may be times when it is necessary to choose certain components to accomplish a particular job. If the job is complex and there are a number of possible sets of components to satisfy the job, it can be difficult to determine the best set of components to use. At other times, the best set of components may be a function of the desire for low price and/or high performance so that different sets of components may provide a solution. An understanding of this problem can be provided through some examples.

In one example, consider a possible manufacturing line. The manufacturing line may include four conveyors, ten presses, ten hot rollers, eight quenchers, and twenty lathes. Each of these pieces of equipment must be controlled by one or more controllers.

A supplier supplies one controller that will control a total of ten pieces of equipment selected from a group consisting of two conveyors, five presses, ten hot rollers and ten lathes. The supplier offers a second controller that will control a total of fifteen pieces of equipment selected from a group consisting of two conveyors, five presses, ten hot rollers, four quenchers and fifteen lathes. The supplier may supply other controllers having other configurations.

The owner of the manufacturing line must determine which combinations of controllers available from the supplier will control the combination of equipment. Of all the possible combinations of controllers, it is also important to determine the least cost or best performance combination of controllers that will control the equipment.

Consider another example, where a purchaser of a building wishes to provide one thousand digital communication lines in the building from a connection with one hundred telephone lines from a telephone central office using a certain number of switches. The building currently has a single telephone switch box that will accommodate eight control cards. Each additional telephone switch box is a substantial cost. A number of control cards are available on the market that provide a certain total number of lines, some digital and some central office type, and a certain number of switches. The owner must determine if there is a set of control cards that totals eight or less which will meet the desired requirements.

In each of these situations, one or more components exist, each of which has certain characteristics. In these examples, each component meets a certain function or provides a certain resource. The characteristics of the components must be compared against the desired characteristics or resources which are desired.

This task can be extremely difficult and time consuming. This is especially true if a large number of components must be considered and a large number of different resources are desired and provided by the components.

For example, just a few components providing several different characteristics may yield tens of thousands of combinations of components which may need to be considered. It is possible to identify each of these combinations. It is desirable, however, to limit the number of combinations which will be evaluated or considered at all.

It is also very difficult at times to determine if a particular set of components even meets the required characteristics. For example, in the example above, it may be relatively easy to determine whether the manufacturing line equipment can be controlled by a set of controllers when considering only the number of each type of equipment a set of controllers can control. However, the total number of pieces of all different types of equipment that can be controlled by a particular controller is less than the sum of the numbers of individual types of equipment that may be controlled by the controller. Thus, the number of each type of equipment which is controlled by the controller must be selected so as not to exceed the total pieces of equipment that can be controlled by that controller. A convenient and efficient manner for determining whether a particular set of components meets the satisfies the desired characteristics is thus also desired.

### SUMMARY OF THE INVENTION

The invention is a method and apparatus for determining an arrangement of components. More particularly, the invention is a method and apparatus for determining arrangement(s) of at least one component that satisfy a set of characteristics or criteria.

In accordance with an embodiment of the method of the invention, a number of components are arranged or ordered in a superior/inferior hierarchy. Sets of components are generated in accordance with the hierarchy of components. A first set of at least one component is selected and a determination is made as to whether the set of components satisfies a required set of characteristics. If the requirements are not satisfied, other non-inferior sets of components are evaluated. If the requirements are satisfied, other non-superior sets of components are evaluated.

In accordance with the method, a minimal number of sets or combinations of at least one component are evaluated to determine those which satisfy the require set of characteristics. When more than one set of at least one component is identified as satisfying the characteristics, in an additional step an optimal set of components may be identified.

In one or more embodiments, each component of a type that provides an amount of at least one individual resource and that has a total capacity of resources of all types which may be provided. A determination of whether a set of components satisfies a required set of resources comprises allocating resources provided by the components of the set in an order of least to most plentiful, and in a manner whereby the allocation of each particular resource tends to equalize the difference between each component's total remaining capacity and a threshold value after the allocation. The threshold value is a value equal to or less than the minimum of any particular resource which may be provided by the component but which has not yet been allocated.

The allocation continues until all of the required resources have been satisfied or can not be satisfied. Multiple sets of components which satisfy the required characteristics may be compared to determine an optimal combination of components.

One or more embodiments comprise a computer program product, system or apparatus for determining a set of components. Further objects, features, and advantages of the present invention over the prior art will become apparent from the detailed description of the drawings which follows, when considered with the attached figures.

### BRIEF DESCRIPTION OF THE DRAWINGS

FIG. 1 is a flowchart illustrating an embodiment of a method of the invention;

FIG. 2 is a table illustrating characteristics of a number of components which may be evaluated in determining an arrangement of components which satisfies a set of characteristics;

FIG. 3 is a hierarchical map of the components listed in the table in FIG. 2;

FIG. 4 illustrates a required resource or characteristic set;

FIG. 5 is a flowchart illustrating a method of allocating resources from a set of components against a set of characteristics or resources in accordance with an embodiment of the invention;

FIG. 6 diagrammatically illustrates one embodiment of a computer system capable of providing a suitable execution environment for an embodiment of the present invention; and

FIG. 7 illustrates a component set determinant system in accordance with an embodiment of the invention.

### DETAILED DESCRIPTION OF THE PREFERRED EMBODIMENT

The invention is an apparatus and method for determining an arrangement of components. In the following description, numerous specific details are set forth in order to provide a more thorough description of the present invention. It will be apparent, however, to one skilled in the art, that the present invention may be practiced without these specific details. In some instances, well-known features may have not been described in detail so as not to obscure the invention.

Method for Determining an Arrangement of Components

One embodiment of the invention comprises a method for determining an arrangement of components. In one or more embodiments, the method is arranged to determine the existence of one or more sets of at least one component which satisfy a set of characteristics, and if more than one such set exists, an optimal set of those sets.

In one or more embodiments, specific component(s) are identified for consideration in the method. The components may be identified by a potential user of them, from a selection of components provided by a vendor, or by a wide variety of other criteria. The term “component” as used herein generally refers to a thing which is under consideration, and may be any object or item, real or imaginary. The term “characteristic” generally refers to a feature, function, capacity or other attribute or property of or associated with, defined or provided by the component. As one specific example set forth below, each component may comprise an internally or externally controlled controller which provides one or more resources, such as the ability to control one or more items.

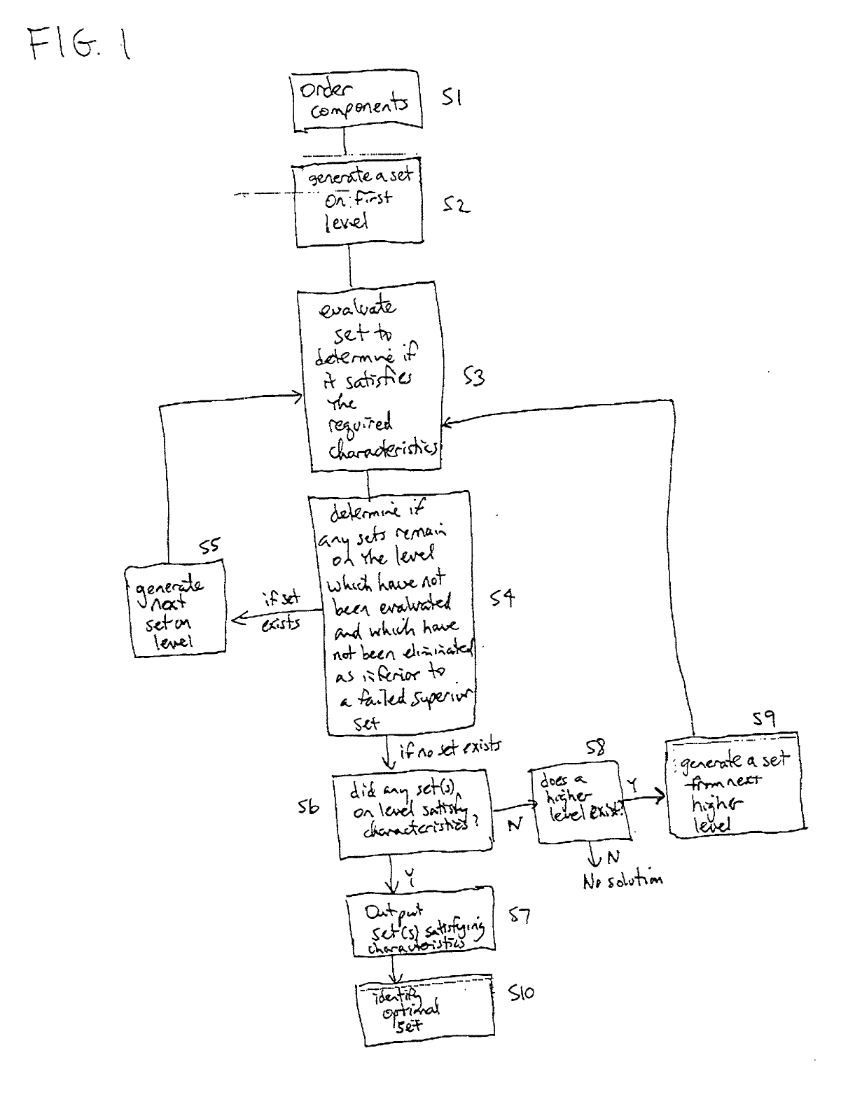

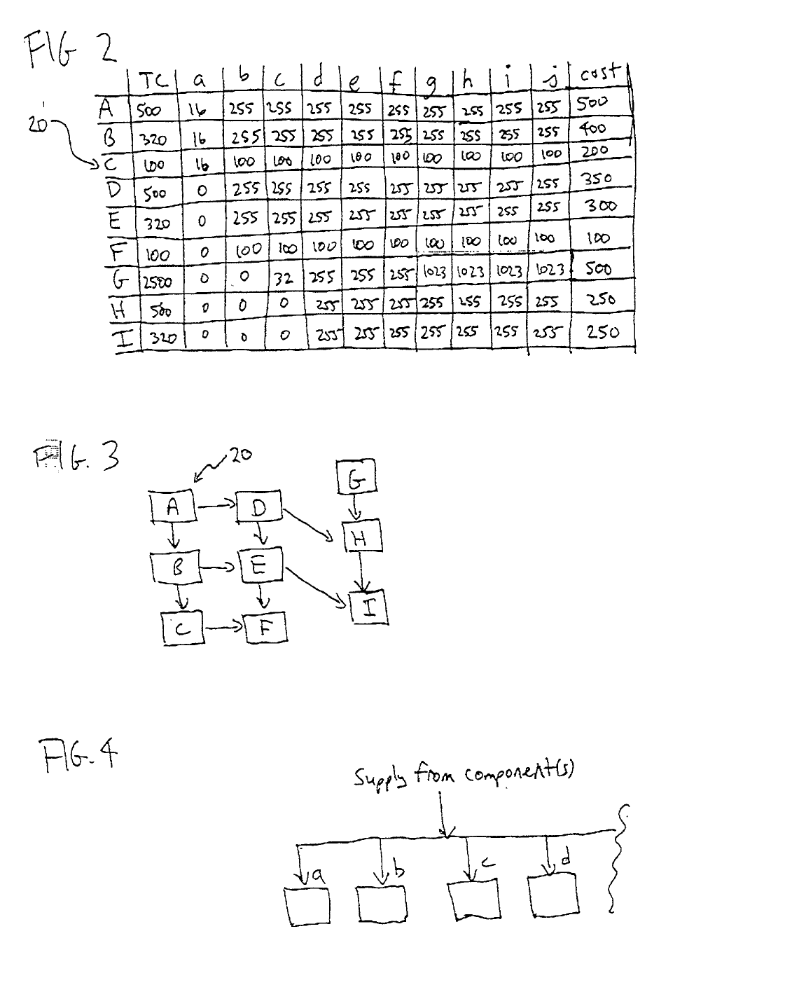

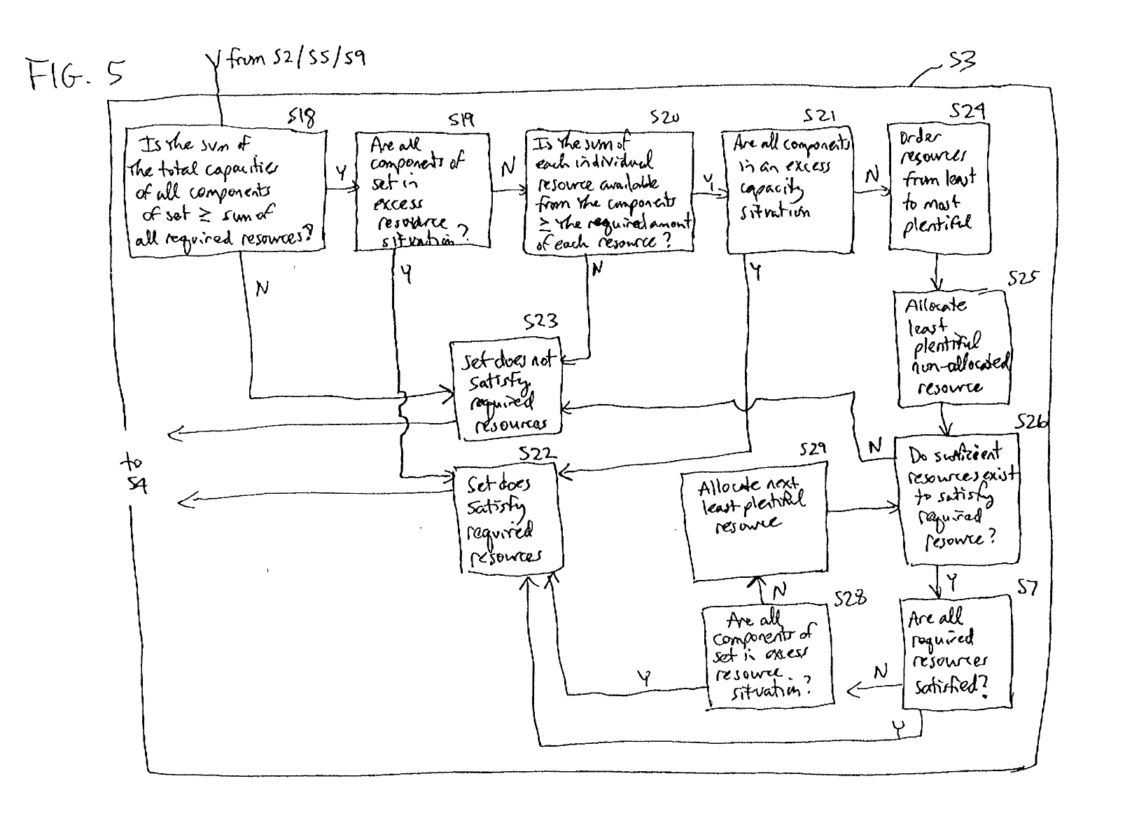

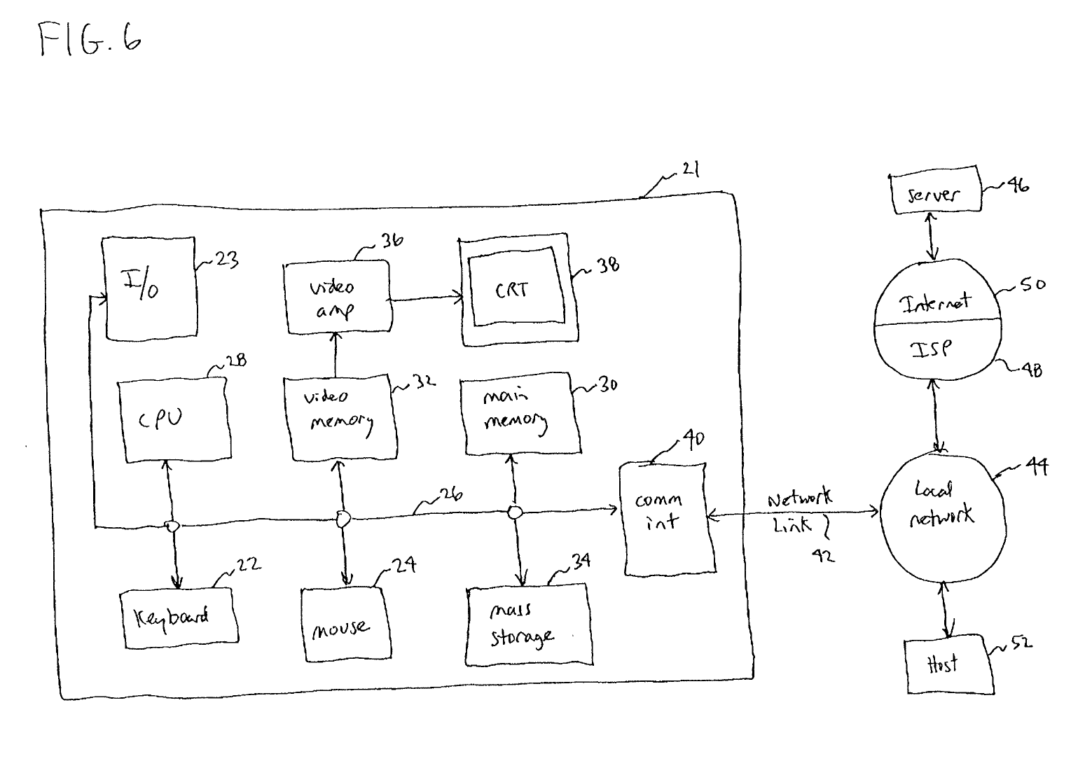

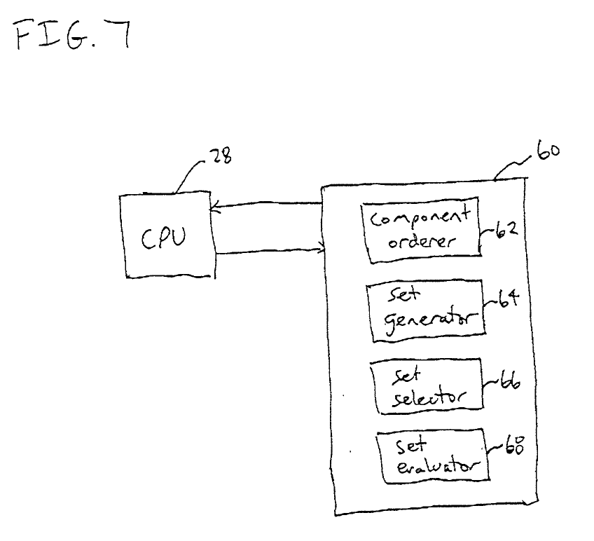

Referring to FIG. 1, in a first step S1 of one embodiment of the method, a component or components are arranged or ordered. In one or more embodiments, the components are arranged in hierarchical fashion in accordance with determined superior/inferior relationships.

The criteria for determining a superior/inferior relationship may vary. In one embodiment, the relationships are determined from at least a relative comparison of the characteristics of the components being considered. In one or more embodiments, if a first component has characteristics which are strictly a sub-set of a second component's characteristics, the first component is inferior to the second.

An example of this step will be described with reference to FIGS. 2 and 3. FIG. 2 illustrates certain characteristics of a number of components 20. These components 20 are labeled A, B, C, D, E, F, G, H, and I. Each component 20 is capable of providing a certain amount of one or more resources a, b, c, d, e, f, g, h, i and j. In addition, a characteristic of each of these components 20 is that the sum total of all resources of all types which may be provided by the component 20 is limited. This total capacity limit is referred to as “TC.”

FIG. 3 is a “map” of these components 20 when arranged in an order or hierarchy in accordance with step S1 of the method. This map is for illustration purposes only. The components 20 also need not be physically or diagrammatically arranged or ordered. In one or more embodiments, step S1 requires only an identification of an order of the components 20. This may be accomplished by physical ordering or mapping, but also by associating a ranking with the components 20 or the like.

In this example, the order of the components 20 listed in FIG. 2 is based on a comparison of the resource characteristics of the components. If a particular component 20 provides a strict sub-set of the characteristics (i.e resources and total capacity in this case) of another component, the component is inferior. As illustrated by FIG. 3, component A is superior to all other components except component G, since component A is capable of providing each particular resource in an amount greater or equal to that provided by components B, C, D, E, F, H and I, and has a total capacity which is greater than or equal to each of these other components. In other words, components B, C, D, E, F, H, and I have resource characteristics which are sub-sets of the resource characteristics of component A.

Likewise, component B is superior to components C, E, F and I. Component C is superior to component F. Component D is superior to components F, H and I. Component E is superior to components F and I. Component F is superior to no other components. Component G is superior to components H and I. Component H is superior to component I. Component I is superior to no other components.

A wide variety of criteria may be examined when determining the order or hierarchy of the components 20. By way of example, the components 20 may be ordered by considering characteristics such as size, weight, longevity and/or cost.

In one or more embodiments, the additional characteristic of the acquisition cost of each component 20 is also considered in determining the order of the components. In one embodiment, if a component 20 is considered inferior based on criteria other than acquisition cost and that component has a lower acquisition cost than the components 20 to which it is inferior, the order of the components 20 is unaffected. This arrangement is illustrated in FIGS. 3 and 4. Here, each component 20 which is considered inferior based on resource characteristics has a cost which is less than the cost of the component(s) which are superior to it.

In one or more embodiments, if a component 20 is inferior based on criteria other than acquisition cost and that component has a higher acquisition cost than the component(s) 20 to which it is inferior, that inferior component is eliminated from consideration and not placed in the ordered set of components.

In one or more embodiments, costs other than or in addition to acquisition cost may be considered when determining an order or hierarchy of the components. For example, costs associated with maintenance and overhead may be considered. In one embodiment, if a component 20 provides resources in an amount equal to half of a superior component, and has an acquisition cost half of the acquisition cost of the superior component, the inferior component 20 may still be removed from consideration. In this embodiment, it is assumed that even if two of the inferior components 20 provided the same resources as a single superior component at the same acquisition cost, post-acquisition costs, such as maintenance and the like, may make the total cost associated with the two inferior components greater than the single superior component.

There may be only one component 20 under consideration, in which case there is no arrangement of components 20. In addition, even where there are multiple components 20 under consideration it may not be readily possible to identify superior-inferior component relationships. As an example, when considering components having characteristics such as those identified in FIG. 2, all components might have a relationship similar to that of components A and G, where no clear superior-inferior component relationship is identifiable. Set forth below is such an example. In this example, components A, B and C are each capable of providing certain resources a, b, c and d as limited by a total capacity TC.

| | TC | a | b | c | d |
|---|---|---|---|---|---|
| A | 500 | 400 | 300 | 200 | 100 |
| B | 500 | 250 | 250 | 250 | 250 |
| C | 500 | 100 | 200 | 300 | 400 |

In this instance, when considering only relative resource and total capacity characteristics, no superior/inferior relationships are identifiable and the components 20 may all be considered “equal.”

In the embodiment of the method illustrated in FIG. 1, in step S2, a first set of at least one component(s) is selected for evaluation. In one embodiment, the first set selected is a set from a first or lowest level which is not inferior to another other set of that level.

In this embodiment, multiple levels of sets are defined, with the set(s) of a particular level arranged in superior/inferior relationships dependent upon the order or hierarchy of the components determined in step Si. In one or more embodiments, a level is defined for each numerically increasing number of components in a set, starting with sets containing the fewest component(s). In this arrangement, a lowest or first level comprises sets containing a single component 20. A second level comprises sets containing two components 20. A third level comprises sets containing three components 30.

As an example, when the set(s) of components 20 are defined from those components illustrated in FIG. 3, a first level comprises a set containing component A, a set containing component B, a set containing component C, etc. A second set level includes all sets containing two components in any order (i.e. a set containing A and B is the same as a set containing B and A), such as a set containing two of component A and a set containing components A and B.

Within each level, the sets of at least one component 20 are defined or arranged in an order or hierarchy. In one embodiment, the order of the sets of a level are ordered in accordance with the superior/inferior relationships of the components 20.

Table 1 in the Appendix set forth below illustrates what would be the arrangement of the sets of the components 20 illustrated in FIGS. 2 and 3 if all of the sets through the first three levels were created or generated at one time. The first level comprises a set containing each of the individual components A-I. The order of the sets in the first level is the same as the order of the individual components as illustrated in FIG. 3: a set containing component A is superior to all sets except a set containing component G. The second level comprises sets containing pairs of components A-I. A set comprising two of component A, component A and G or two of component G are superior to all other pairs of components.

As in the case of the order of the individual components 20, certain sets of at least one component may not be identifiable as either superior or inferior to another. An example of this situation is a set comprising two of component A as compared to a set comprising two of component G.

In one or more embodiments, in step S2 only the first, single set is generated for evaluation. This avoids the time consuming aspect of generating all sets even though it may later be determined that a substantial number of the sets may not need to be evaluated.

In the example illustrated in Table I in the Appendix, the first set generated or selected is either that set containing component A or the set containing component G. All other sets of the first level (i.e. containing only a single component) are inferior to the set containing component A and/or the set containing component G.

In a step S3, it is determined if the selected set of component(s) satisfies a set of characteristics. In one or more embodiments, the characteristics are pre-selected sets of required or desired characteristics, such as the needs of a particular business or company.

For example, referring to FIG. 4, it may be desired that a particular set of component(s) provide an amount “w” of a type “a” resource, an amount “x” of a type “b” resource, an amount “y” of a type “c” resource, an amount “z” of a type “d” resource and so on. In such an arrangement, the step S4 comprises the step of determining or evaluating whether the component(s) of the set are capable, in any allocation or distribution, of providing the require resources of each type. A method for determining whether a particular set of component(s) satisfies a set of required characteristics is described in greater detail below.

In a step S4, it is determined if there are any sets on the present level which have not already either been evaluated and are not excluded as being inferior to a set which was evaluated and failed step S4. If such a set exists, then in step S5 that set is generated, and then in step S4, evaluated. In other words, each set on a given level is either evaluated directly into a pass/fail situation, or is eliminated (or deemed to fail) as being inferior to a set which evaluated and failed.

If no other set(s) remain to be evaluated on a particular level, then in step S6, it is determined if any of the sets evaluated previously in step S4 satisfied the characteristics. If so, then these set(s) are output or identified in step S7.

If in step S6 it is determined that no set satisfied the characteristics in step S4, then in a step S8, it is determined if there are any more levels of set(s) to evaluate. If not, there is no solution. If so, in a step S9 a first set is generated at the next level. The first set at the next level is then evaluated in step S4. Each set on that next level is then either evaluated directly or eliminated as inferior to a failed set, via repeating steps S3-S5. Again, if no set which satisfies the characteristics is found, in step S8 it is determined if another level of sets exist which can be evaluated.

An example of the above-referenced steps S3-S9 as applied to the sets of components 20 listed in Table I of the Appendix is as follows. In step S2, the first set which is selected for evaluation is the set comprising component A. If this set satisfies the requirements in step S3, then in step S4 it is determined that other set(s) on the level exist to be evaluated. There are such sets, including set B. If this set fails, then the sets comprising components C, E, F, and I are deemed to fail as being inferior. A next set on that level which has not been evaluated or deemed to fail by being inferior to a failed set is then generated, such as a set comprising component G.

If the evaluation of the first set comprising component A resulted in a finding that the set did not satisfy the requirements (as in the arrangement illustrated in Table I), then in a step S4 it is determined that another set still exists on the first level to evaluate: the set comprising component G (all other sets in the first level are eliminated along with the set comprising component A since the sets are inferior to that set). This set is selected and evaluated in step S3. If the set comprising component G does not satisfy the requirements (as in the arrangement illustrated in Table I), with no other sets to evaluate on that level, and with no set satisfying the characteristics, in step S8 it is determined if another level of set(s) exists. The answer to this question is yes, and in step S9, a first set from level two is generated, such a set comprising components A,A A,G or G,G. This set is evaluated in step S3 and the process repeats until one or more sets are found on a level which satisfy the characteristics or all sets have been deemed to fail at all levels.

Table I in the Appendix illustrates the outcome a particular comparison of the sets of components therein to a required set of resources. An important aspect of the invention is illustrated by this table: because the sets of components are arranged based on a the hierarchy of components 20, certain sets of components may not be analyzed or compared at all during the evaluation process (step S4 of the method illustrated in FIG. 1). In fact, the other non-evaluated sets are not even generated.

For example, still referring to Table I, in the first level, only the two sets containing components A and G are generated and analyzed. If the sets are arranged or determined before the sequence of steps S4-S10 in the method described above, no consideration of the other sets in the first level occurs. The speed and efficiency of the method is enhanced in this arrangement by eliminating the repeated step of determining if a particular set is inferior or superior to another set during each iteration of the evaluation process.

One embodiment of a method for determining whether a particular set of components satisfies certain required characteristics, in accordance with step S4 of the method illustrated in FIG. 1, will now be described. This method is particularly applicable where each component 20 provides one or more individual resources or other desired characteristics and where a total number or amount of the resources or characteristics which may be provided are potentially limited by another characteristic of the component. Components of this type are listed in the table illustrated in FIG. 2.

If each characteristic or individual resources which may be provided by each component 20 in the set are not limited by the total capacity or other limiting factor associated with the component, then the individual characteristics or resources which may be provided by the components 20 of the set are simply compared against the required characteristics. For example:

| | TC | a | b | c |
|---|---|---|---|---|
| A | 500 | 100 | 200 | 100 |
| B | 400 | 100 | 100 | 200 |
| Total | | 200 | 300 | 300 |
| Required | | 200 | 300 | 300 |

In this case the total of each individual resource which may be is provided by the set comprising components A and B equals or exceeds the amount or number of each individual resource required, satisfying the required characteristics. This may be referred to as an “excess capacity” situation, since the total capacity of the component(s) is irrelevant and it only needs to be determined if sufficient quantities of the individual resources can be supplied by the components 20.

In another situation, a component 20 may have a total capacity which is less than or equal to the smallest number of individual resources which it is capable of providing. Set forth below is an example of a component 20 of this type:

| | TC | a | b | c |
|---|---|---|---|---|
| A | 100 | 300 | 200 | 100 |

Those of skill in the art will appreciate that any set of required characteristics or resources can be satisfied if a sufficient number of the components 20 are provided so that the sum total capacities exceed the total of the required resources, since no situation will arise when that set of components will have a shortage of individual resources. This may be referred to as the “excess resource” situation.

Some components 20 have characteristics which render them other than of the “excess capacity” or “excess resource” type. In one or more embodiments, the resources associated with such a set of components 20 are allocated or evaluated so that each component 20 of that set reaches an “excess resource” situation. By the term allocate it is meant that a determination is made as to whether a particular set of characteristics can be met by a set of components 20-i.e. a comparison or evaluation. This evaluation need not be a physical allocation but may be diagrammatic, mathematic or the like.

Once such a condition is reached, it is known that the set of components 20 will satisfy the required characteristics if the remaining total capacities of the component(s) exceeds the remaining require resources.

It is also known that if the total capacity of all of the component(s) of a set is less than the total of all resources required, the set can not satisfy the required characteristics or resources. In addition, if the total of any individual resource which can be provided by all component(s) 20 of the set is less than the total of any individual resource or characteristic required, then the set can not satisfy the required characteristics or resources.

FIG. 6 illustrates an embodiment of the method in which the above-stated concepts and comparisons comprise a part of the evaluation of whether the set of at least one component satisfies the required characteristics. In the specific embodiment illustrated, this comparison comprises a portion of step S4 of the method illustrated in FIG. 1.

As illustrated therein, in a step S18, it is determined if the sum of the total capacity of each component in the set is greater than or equal to the sum of all resources which are required. If not, then it is immediately known, as in step S23, that the set will not satisfy (in any allocation arrangement) the characteristics. The method may then continue to the next step, such as step S6 in FIG. 1.

If so, then in step S19 it is determined if all of the components 20 of the set are in an excess resource condition. If so, it is then known that the components 20 of the set have sufficient capacity and resources to satisfy the characteristics or resources required, as in step S22. The method may then continue to the next step, such as step S6 in FIG. 1.

If all components are not in an excess resource condition, then in step S20 it is determined if the sum of each individual resource available from the component(s) of the set is greater than or equal to the amount of each individual resource required. If not (i.e. the sum of any individual resource which may be provided from all of the components is less than the amount of a particular resource required) then it is known, as in step S23, that the set can not satisfy the required resources or characteristics.

If step S20 is satisfied, then it is determined if all of the components 20 of the set are in the excess capacity situation. If so, then it is known that the components 20 can satisfy the required resources (step S22).

If all of the components 20 are not in the excess capacity situation, then in a step S24, before evaluating that set of components 20, the characteristics or resources which are available from the component(s) of the set are ordered from least to most plentiful. A variety of criteria may be used to determine if a particular resource is the least or most plentiful. In general, it is desired to order the resources so as to minimize the possibility of having a particular component 20 run out of total capacity before running out of resources of a particular type. As an example, assume components A, B and C are capable of providing resources a, b, and c in the amounts listed, as potentially limited by a total capacity TC of the component, as follows:

| | TC | a | b | c |
|---|---|---|---|---|
| A | 500 | 100 | 400 | 100 |
| B | 500 | 50 | 100 | 300 |
| C | 500 | 100 | 150 | 200 |

Then the resources available from the components are reordered as follows:

| | Most | | | Least |
|---|---|---|---|---|
| | Plentiful | | | Plentiful |
| | TC | b | c | a |
| A | 500 | 400 | 100 | 100 |
| B | 500 | 100 | 300 | 50 |
| C | 500 | 150 | 200 | 100 |

In a next step S25, the least plentiful resources are allocated from the components 20 to the required resources or characteristics. In step S26 it is determined whether the resources or characteristics can be allocated or assigned in an amount which does not violate or exceed the total capacity of the component 20 or the amount of the particular resource available from a component 20. If such a violation occurs, then the set will not satisfy the characteristics.

If, in a step S27 it is determined that all of the characteristics or resources have or can be met by the component(s) of the set after the allocation, then it is determined in a step S22 that the set satisfied the characteristics. If all of the characteristics have not yet been satisfied, then in a step S28 it is determined if all of the components 20 are in an “excess resource” condition. If so, it is known that the set satisfies the characteristics (step S22).

If in step S28 it is determined that all of the components 20 are not in the “excess resource” condition, then in a step S30 the next least plentiful resource is allocated, and the process repeats with step S26.

In one or more embodiments, the resources which are supplied or allocated (i.e. steps S26, and step S29) from each particular component in a manner which maximizes the equality of the difference between each component's total remaining capacity and a threshold value after the allocation. The “threshold value” is a value equal to the minimum or lowest number or amount of any particular resource available from the component 20 which has yet to be allocated. Because the threshold is based on the unallocated resource availability, the threshold for each component 20 may change after the allocation of a particular resource.

A set of components is set forth below, listing the threshold of each component before any resources have been allocated, and with available resources arranged from least to most plentiful.

| | TC | a | b | c | d | threshold |
|---|---|---|---|---|---|---|
| A | 500 | 400 | 300 | 200 | 100 | 100 |
| B | 500 | 400 | 300 | 200 | | 200 |
| C | 500 | 400 | 300 | | | 300 |

The least plentiful resources is allocated from each component 20 so that the difference between the total remaining capacity and threshold after the allocation for each component is generally equal, while not exceeding the total capacity or individual availability of the resource being allocated, and while attempting to satisfy the desired characteristic. Set forth below is an example:

| | TC | a | b | c | d | threshold |
|---|---|---|---|---|---|---|
| A | 500 | 400 | 300 | 200 | 100 | 100 |
| B | 500 | 400 | 300 | 200 | | 200 |
| C | 500 | 400 | 300 | | | 300 |
| required | | 825 | 300 | 300 | 60 | |

In a first step, 60 of resource d is allocated from component A to meet the require characteristics, since no other component can provide this least available resource. After this allocation, the total capacity remaining (TCR) of component A and its threshold changes. In particular, the threshold of component A rises to 200, which is the minimum amount of any unallocated resources (a, b and c) remaining.

| | TCR | a | b | c | d | threshold |
|---|---|---|---|---|---|---|
| A | 440 | 400 | 300 | 200 | 40 | 200 |
| B | 500 | 400 | 300 | 200 | | 200 |
| C | 500 | 400 | 300 | | | 300 |
| supplied | | | — | — | — | 60 |
| required | | | 825 | 300 | 300 | 60 |

Only components A and B can provide the next least plentiful resource, resource c. The difference between the TCR and threshold for component A after the allocation of resource c should be as close as possible to the difference between the TCR and threshold for component B after the allocation of resource c. This may be accomplished mathematically with the following equations: if an amount x of resources c is allocated from component A and an amount y of resources c is allocated from component B, x+y=300, since 300 resources c are required. In addition the difference between the TCR of component A after allocation (440−x) and the new threshold (300) should equal the difference between the TCR of component B after allocation (500−y) and the its new threshold (300), such that (440−x)300=(500−y)−300, or x+60=y, which when substituted in the equation x+y=300 yields x=120 and y=180.

| | TCR | a | b | c | d | threshold |
|---|---|---|---|---|---|---|
| A | 320 | 400 | 300 | 80 | 40 | 300 |
| B | 320 | 400 | 300 | 20 | | 300 |
| C | 500 | 400 | 300 | | | 300 |
| supplied | | | | 300 | 60 | |
| required | | 825 | 300 | 300 | 60 | |

Again, in the next allocation, it is desired that the difference between the TCR and threshold for components A, B and C after allocation of resource b remain as equal as possible. This requires that 40 of resource b be allocated from components A and B, and 220 from component C.

| | TCR | a | b | c | d | threshold |
|---|---|---|---|---|---|---|
| A | 280 | 400 | 260 | 80 | 40 | 400 |
| B | 280 | 400 | 260 | 20 | | 400 |
| C | 280 | 400 | 80 | | | 400 |
| supplied | | | 300 | 300 | 60 | |
| required | | 825 | 300 | 300 | 60 | |

Now as long as the sum of the TCR for components A, B, and C is greater than the required resource a, a solution is guaranteed (i.e. the set of components will satisfy the set of characteristics), since each component 20 is in the “excess resource” condition (that is, the TCR for each component is less than or equal to its threshold value). Thus, the further step of allocating resource a does not need to be performed, further reducing the effort needed to determine if the set of components satisfies the required characteristics. If the allocation is performed, the remaining and distributed resources corresponding to the components 20 may appear as follows:

| | TCR | a | b | c | d |
|---|---|---|---|---|---|
| A | 5 | 125 | 260 | 80 | 40 |
| B | 5 | 125 | 260 | 20 | |
| C | 5 | 125 | 80 | | |
| supplied | | 825 | 300 | 300 | 60 |
| required | | 825 | 300 | 300 | 60 |

As a further aspect of the invention, in one or more embodiments, if more than one set or combination of component(s) are identified in as satisfying the characteristics (i.e. step S7 in FIG. 1), then these sets may be further analyzed to determined an optimal set of the sets. Such a step is illustrated in FIG. 1 as step S10.

For example, it may be determined that a set comprising components A and A and a set comprising components A and G both satisfy the required characteristics. These sets of components may be further compared to identify the optimal arrangement. For example, the total cost of the combinations of components may be used as a final determinant of the optimal solution.

Embodiment of Computer Execution Environment (Hardware)

One or more embodiments of the invention can be implemented as computer software in the form of computer readable code executed on a computer, such as that illustrated in FIG. 6, or in the form of bytecode class files executable within a Java runtime environment running on such a computer.

Such a computer 21 may include, but is not limited to that illustrated in FIG. 6. In this arrangement, the computer 21 includes a keyboard 22 and a mouse 24 coupled to a bidirectional system bus 26. The keyboard 22 and mouse 24 are for introducing user input to the computer system and communicating that user input to a processor 28. Other suitable input devices may be used in addition to, or in place of, the mouse 24 and the keyboard 22. An I/O (input/output) unit 23 coupled to a bidirectional system bus 26 represents such I/O elements as a printer, A/V (audio/video) I/O, etc.

The computer 210 includes a video memory 32, a main memory 30 and a mass storage 34, all coupled to the bidirectional system bus 26 along with the keyboard 22, the mouse 24 and the processor 28. The mass storage 34 may include both fixed and removable media, such as magnetic, optical or magnetic optical storage systems or any other available mass storage technology. The bus 26 may contain, for example, thirty-two address lines for addressing a video memory 32 or a main memory 30. The system bus 26 also includes, for example, a 32-bit data bus for transferring data between and among the components, such as the processor 28, the main memory 30, the video memory 32 and the mass storage 34. Alternatively, multiplex data/address lines may be used instead of separate data and address lines.

In one embodiment of the invention, the processor 28 is a microprocessor manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer may be utilized. The main memory 30 is comprised of dynamic random access memory (DRAM). The video memory 32 is a dual-ported video random access memory. One port of the video memory 32 is coupled to a video amplifier 36. The video amplifier 36 is used to drive a cathode ray tube (CRT) raster monitor 38. The video amplifier 36 is well known in the art and may be implemented by any suitable apparatus. This circuitry converts pixel data stored in the video memory 32 to a raster signal suitable for use by the monitor 38. The monitor 38 is a type of monitor suitable for displaying graphic images. Alternatively, the video memory could be used to drive a flat panel or liquid crystal display (LCD), or any other suitable data presentation device.

The computer 21 may also include a communication interface 40 coupled to the bus 26. The communication interface 40 provides a two-way data communication coupling via a network link 42 to a local network 44. For example, if the communication interface 40 is an integrated services digital network (ISDN) card or a modem, the communication interface 40 provides a data communication connection to the corresponding type of telephone line, which comprises part of the network link 42. If the communication interface 40 is a local area network (LAN) card, the communication interface 40 provides a data communication connection via the network link 42 to a compatible LAN. The communication interface 40 could also be a cable modem or wireless interface. In any such implementation, the communication interface 40 sends and receives electrical, electromagnetic or optical signals which carry digital data streams representing various types of information.

The network link 42 typically provides data communication through one or more networks to other data devices. For example, the network link 42 may provide a connection through a local network 44 to a local server computer 46 or to data equipment operated by an Internet Service Provider (ISP) 48. The ISP 48 in turn provides data communication services through the world wide packet data communication network now commonly referred to as the “Internet” 50. The local network 44 and Internet 50 both use electrical, electromagnetic or optical signals which carry digital data streams. The signals through the various networks and the signals on the network link 42 and through the communication interface 40, which carry the digital data to and from the computer 21, are exemplary forms of carrier waves transporting the information.

The computer 21 can send messages and receive data, including program code, through the network(s), the network link 42, and the communication interface 40. In the Internet example, a remote server computer 52 might transmit a requested code for an application program through the Internet 50, the ISP 48, the local network 44 and the communication interface 40.

The received code may be executed by the processor 28 as it is received, and/or stored in the mass storage 34, or other non-volatile storage for later execution. In this manner, the computer 21 may obtain application code in the form of a carrier wave.

Application code may be embodied in any form of computer program product. A computer program product comprises a medium configured to store or transport computer readable code or data, or in which computer readable code or data may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment, including embedded devices (e.g., web phones, etc.) and “thin” client processing environments (e.g., network computers (NC's), etc.) that support a virtual machine.

In one or more embodiments, and as illustrated in FIG. 7, the computer 21 includes a component set determinant system 60. This system 60 may comprise hardware and/or software associated with the computer 21 and/or CPU 28.

In one embodiment, the system 60 is associated with the CPU 28 and includes a component orderer 62, a set generator 64, a set selector 66, and set evaluator 68. The component ordered 62 is generally arranged to determine a hierarchy of the components 20, such as in accordance with step S1 of the method illustrated in FIG. 1.

The set generator 64 determines sets of at least one component, such as the arrangement of sets illustrated in Table I in the appendix and in accordance with steps S2, S5 and S9 of the method illustrated in FIG. 1.

The set selector 66 is arranged to determine the particular set which is to be evaluated by the set evaluator 68. The set evaluator 68 is arranged to determine if the selected set satisfies the required characteristics, such as in accordance with step S3 illustrated in FIGS. 1 and 5.

One feature of the invention is that an optimum (such as least cost) set of components may easily be identified which provides or meets a set of characteristics.

An advantage of the invention is that in many instances substantially less than the total number of all combinations or sets of components need to be evaluated. The arrangement of components 20 in hierarchical superior/inferior relationships eliminates the need in many instances to consider certain combinations or sets of the components 20. When the inferior/superior set relationships are defined before the evaluation process, the repeated step of comparing sets to one another during the processes of evaluating certain of the sets is eliminated, speeding the evaluation process.

Another advantage of the invention is that a simple arrangement is provided for determining whether a set of components has characteristics or can provide resources which meet required characteristics or resources. In accordance with one or more embodiments of the invention, one or more steps of allocating resources to determine if a set of components meets the required characteristics may be avoided when the resources of the components are allocated in a manner which results in each component being in an “excess resource” situation. If only a single set of at least one component is identified which satisfies the characteristics, that set may be considered the optimal set. When more than one set is identified, an optimal set may be readily determined by comparing one or more characteristics (such as acquisition cost) of the few identified sets.

Of course, the foregoing description is that of preferred embodiments of the invention, and various changes and modifications may be made without departing from the spirit and scope of the invention, as defined by the claims.

### APPENDIX

TABLE I

| | |
|---|---|
| Level 1 | |
| A | fails |
| B | inferior to A |
| C | inferior to A |
| D | inferior to A |
| E | inferior to A |
| F | inferior to A |
| G | fails |
| H | inferior to A, G |
| I | inferior to A, G |
| Level 2 | |
| AA | fails |
| AB | inferior to A-A |
| AC | inferior to A-A |
| AD | inferior to A-A |
| AE | inferior to A-A |
| AF | inferior to A-A |
| AG | fails |
| AH | inferior to A-A, A-G |
| AI | inferior to A-A, A-G |
| BB | inferior to A-A |
| BC | inferior to A-A |
| BD | inferior to A-A |
| BE | inferior to A-A |
| BF | inferior to A-A |
| BG | inferior to A-G |
| BH | inferior to A-A, A-G |
| BI | inferior to A-A, A-G |
| CC | inferior to A-A |
| CD | inferior to A-A |
| CE | inferior to A-A |
| CF | inferior to A-A |
| CG | inferior to A-G |
| CH | inferior to A-A, A-G |
| CI | inferior to A-A, A-G |
| DD | inferior to A-A |
| DE | inferior to A-A |
| DF | inferior to A-A |
| DG | inferior to A-G |
| DH | inferior to A-A, A-G |
| DI | inferior to A-A, A-G |
| EF | inferior to A-A |
| EF | inferior to A-A |
| EG | inferior to A-G |
| EH | inferior to A-A, A-G |
| EI | inferior to A-A, A-G |
| FF | inferior to A-A |
| FG | inferior to A-G |
| FH | inferior to A-A, A-G |
| FI | inferior to A-A, A-G |
| GG | fails |
| GH | inferior to G-G |
| GI | inferior to G-G |
| HH | inferior to A-G, G-G |
| HI | inferior to A-G, G-G |
| II | inferior to A-G, G-G |
| Level 3 | |
| AAA | fails |
| AAB | inferior to A-A-A |
| AAC | inferior to A-A-A |
| AAD | inferior to A-A-A |
| AAE | inferior to A-A-A |
| AAF | inferior to A-A-A |
| AAG | succeeds |
| AAH | inferior to A-A-A |
| AAI | inferior to A-A-A |
| ABB | inferior to A-A-A |
| ABC | inferior to A-A-A |
| ABD | inferior to A-A-A |
| ABE | inferior to A-A-A |
| ABF | inferior to A-A-A |
| ABG | fails |
| ABH | inferior to A-A-A, A-B-G |
| ABI | inferior to A-A-A, A-B-G |
| ACC | inferior to A-A-A |
| ACD | inferior to A-A-A |
| ACE | inferior to A-A-A |
| ACF | inferior to A-A-A |
| ACG | inferior to A-B-G |
| ACH | inferior to A-A-A, A-B-G |
| ACI | inferior to A-A-A, A-B-G |
| ADD | inferior to A-A-A |
| ADE | inferior to A-A-A |
| ADF | inferior to A-A-A |
| ADG | fails |
| ADH | inferior to A-A-A, A-D-G |
| ADI | inferior to A-A-A, A-D-G |
| AEE | inferior to A-A-A |
| AEF | inferior to A-A-A |
| AEG | inferior to A-B-G, A-D-G |
| AEH | inferior to A-B-G, A-D-G |
| AEI | inferior to A-B-G, A-D-G |
| AFF | inferior to A-A-A |
| AFG | inferior to A-B-G, A-D-G |
| AFH | inferior to A-B-G, A-D-G |
| AFI | inferior to A-B-G, A-D-G |
| AGG | fails |
| AGH | inferior to A-G-G |
| AGI | inferior to A-G-G |
| AHH | inferior to A-A-A, A-G-G |
| AHI | inferior to A-A-A, A-G-G |
| AII | inferior to A-A-A, A-G-G |
| BBB | inferior to A-A-A |
| BBC | inferior to A-A-A |
| BBD | inferior to A-A-A |
| BBE | inferior to A-A-A |
| BBF | inferior to A-A-A |
| BBG | inferior to A-B-G |
| BBH | inferior to A-A-A, A-B-G |
| BBI | inferior to A-A-A, A-B-G |
| BCC | inferior to A-A-A |
| BCD | inferior to A-A-A |
| BCE | inferior to A-A-A |
| BCF | inferior to A-A-A |
| BCG | inferior to A-B-G |
| BCH | inferior to A-A-A, A-B-G |
| BCI | inferior to A-A-A, A-B-G |
| BDD | inferior to A-A-A |
| BDE | inferior to A-A-A |
| BDF | inferior to A-A-A |
| BDG | inferior to A-D-G |
| BDH | inferior to A-A-A, A-D-G |
| BDI | inferior to A-A-A, A-D-G |
| BEE | inferior to A-A-A |
| BEF | inferior to A-A-A |
| BEG | inferior to A-B-G, A-D-G |
| BEH | inferior to A-B-G, A-D-G |
| BEI | inferior to A-B-G, A-D-G |
| BFF | inferior to A-A-A |
| BFG | inferior to A-B-G, A-D-G |
| BFH | inferior to A-B-G, A-D-G |
| BFI | inferior to A-B-G, A-D-G |
| BGG | inferior to A-G-G |
| BGH | inferior to A-G-G |
| BGI | inferior to A-G-G |
| BHH | inferior to A-A-A, A-B-G, A-D-G, A-G-G |
| BHI | inferior to A-A-A, A-B-G, A-D-G, A-G-G |
| BII | inferior to A-A-A, A-B-G, A-D-G, A-G-G |
| CCC | inferior to A-A-A |
| CCD | inferior to A-A-A |
| CCE | inferior to A-A-A |
| CCF | inferior to A-A-A |
| CCG | inferior to A-B-G |
| CCH | inferior to A-B-G |
| CCI | inferior to A-B-G |
| CDD | inferior to A-A-A |
| CDE | inferior to A-A-A |
| CDF | inferior to A-A-A |
| CDG | inferior to A-B-G, A-D-G |
| CDH | inferior to A-A-A, A-B-G, A-D-G |
| CDI | inferior to A-A-A, A-B-G, A-D-G |
| CEE | inferior to A-A-A |
| CEF | inferior to A-A-A |
| CEG | inferior to A-B-G, A-D-G |
| CEH | inferior to A-A-A, A-B-G, A-D-G |
| CEI | inferior to A-A-A, A-B-G, A-D-G |
| CFF | inferior to A-A-A |
| CFG | inferior to A-B-G, A-D-G |
| CFH | inferior to A-A-A, A-B-G, A-D-G |
| CFI | inferior to A-A-A, A-B-G, A-D-G |
| CGG | inferior to A-G-G |
| CGH | inferior to A-G-G |
| CGI | inferior to A-G-G |
| CHH | inferior to A-G-G |
| CHI | inferior to A-G-G |
| CII | inferior to A-G-G |
| DDD | inferior to A-A-A |
| DDE | inferior to A-A-A |
| DDF | inferior to A-A-A |
| DDG | inferior to A-B-G, A-D-G |
| DDH | inferior to A-A-A, A-B-G, A-D-G |
| DDI | inferior to A-A-A, A-B-G, A-D-G |
| DEE | inferior to A-A-A |
| DEF | inferior to A-A-A |
| DEG | inferior to A-B-G, A-D-G |
| DEH | inferior to A-A-A, A-B-G, A-D-G |
| DEI | inferior to A-A-A, A-B-G, A-D-G |
| DFF | inferior to A-A-A |
| DFG | inferior to A-B-G, A-D-G |
| DFH | inferior to A-A-A, A-B-G, A-D-G |
| DFI | inferior to A-A-A, A-B-G, A-D-G |
| DGG | inferior to A-G-G |
| DGH | inferior to A-G-G |
| DGI | inferior to A-G-G |
| DHH | inferior to A-A-A, A-B-G, A-D-G, A-G-G |
| DHI | inferior to A-A-A, A-B-G, A-D-G, A-G-G |
| DII | inferior to A-A-A, A-B-G, A-D-G, A-G-G |
| EEE | inferior to A-A-A |
| EEF | inferior to A-A-A |
| EEG | inferior to A-B-G, A-D-G |
| EEH | inferior to A-A-A, A-B-G, A-D-G |
| EEI | inferior to A-A-A, A-B-G, A-D-G |
| EFF | inferior to A-A-A |
| EFG | inferior to A-B-G, A-D-G |
| EFH | inferior to A-A-A, A-B-G, A-D-G |
| EFI | inferior to A-A-A, A-B-G, A-D-G |
| EGG | inferior to A-G-G |
| EGH | inferior to A-G-G |
| EGI | inferior to A-G-G |
| EHH | inferior to A-A-A, A-B-G, A-D-G, A-G-G |
| EHI | inferior to A-A-A, A-B-G, A-D-G, A-G-G |
| EII | inferior to A-A-A, A-B-G, A-D-G, A-G-G |
| FFF | inferior to A-A-A |
| FFG | inferior to A-B-G |
| FFH | inferior to A-B-G |
| FFI | inferior to A-B-G |
| FGG | inferior to A-G-G |
| FGH | inferior to A-G-G |
| FGI | inferior to A-G-G |
| FHH | inferior to A-A-A, A-B-G, A-D-G, A-G-G |
| FHI | inferior to A-A-A, A-B-G, A-D-G, A-G-G |
| FII | inferior to A-A-A, A-B-G, A-D-G, A-G-G |
| GGG | fails |
| GGH | inferior to G-G-G |
| GGI | inferior to G-G-G |
| GHH | inferior to G-G-G |
| GHI | inferior to G-G-G |
| GII | inferior to G-G-G |
| HHH | inferior to A-A-A, A-B-G, A-D-G, A-G-G |
| HHI | inferior to A-A-A, A-B-G, A-D-G, A-G-G |
| HII | inferior to A-A-A, A-B-G, A-D-G, A-G-G |
| III | inferior to A-A-A, A-B-G, A-D-G, A-G-G |

What is claimed is:

1. A method for determining if an arrangement of at least one component satisfies required resources, each component having a total capacity and capable of supplying an amount of at least one resource of said set, comprising the step of:
determining a hierarchy of said components;
selecting a first set comprising at least one component;
detrmining a threshold value equal to or less than a minimum of any resource of said component which is unallocated;
allocating a first, least available resource from said components to a first resource of said required resources, said first resource allocated from each component in an amount no greater than a maximum amount of said first resource available from said component and maximizing the equality between the difference between each component's total capacity and threshold value after said allocation;
determining if said first required resource is satisfied.

2. The method in accordance with claim 1 further including the step of allocating a second, next least available resource if said first required resource is satisfied.

3. The method in accordance with claim 1 further including the step of determining that said set of at least one component satisfies said required set of resources if the threshold value of each component exceeds that component's total capacity and a sum of individual resources which may be provided by each component exceeds a required amount of each of said resources.

4. The method in accordance with claim 1 further including the step of determining whether a second set comprising at least one component exists which is not superior to said first set in accordance with said hierarchy if said first set satisfies said required set of resources and determining if said second set satisfies said required set of resources.

5. The method in accordance with claim 1 further including the step of determining whether a second set comprising at least one component exists which is not inferior to said first set in accordance with said hierarchy if said first set does not satisfy said required set of resources and determining if said second set satisfies said required set of resources.

6. A computer program product comprising:
a computer usable medium having computer readable program code embodied to determine if a set comprising at least one component satisfies a required set of characteristics comprising:
computer readable program code configured to arranged components in a hierarchy;
computer readable program code configured to cause a computer to determine one or more sets of at least one component based upon said hierarchy;
computer readable program code configured to cause a computer to identify a set of at least one component for evaluation;
computer readable program code configured to cause a computer to determine a threshold value associated with each component of said set to be evaluated;
computer readable program code configured to cause a computer to identify a least plentiful characteristic of from said at least one component of said set to be evaluated;
computer readable program code configured to allocate said least plentiful characteristic in a manner which maximizes the equality of the difference between total remaining capacity and threshold value of each component after the allocation; and
computer readable program code configured to cause a computer to determine if said set of required characteristics is satisfied by said set of at least one component evaluated.

7. A computer system comprising:
a processor;
a computer program executable by said processor, said program arranged to determine if a set of at least one component satisfies a set of required characteristics, said program determining sets of at least one component arranged into a hierarchy; selecting a first set comprising at least one component; determining a threshold value for each component of said first set, said threshold value comprising a value equal to or less than a minimum of any resource of said component which is unallocated; allocating a first, least available resource from said components to a first required resource of said required set of resources, said first resource allocated from each component in an amount no greater than a maximum amount of said first resource available from said component and maximizing the equality of the difference between each components total capacity and threshold value after said allocation; and determining if said first required resource is satisfied.

8. A computer system comprising:
a processor; and
a component determinant system for determining if a particular set of at least one component satisfies a set of characteristics comprising:
a component ordered arranging each component in a hierarchical superior/inferior relationship;
a set generator generating sets of at least one component in an order based upon said relationships of said components;
a set selector for selecting a particular set of at least one component for evaluation; and
a set evaluator determining if said selected set of at least one component satisfies the set of characteristics.
